(19) United States
(12) Patent Application Publication
(10) Pub. No.: US 2022/0073691 A1
(43) Pub. Date: Mar. 10, 2022

(54) FLAME RETARDANT COMPOSITION FOR POLYURETHANE FOAM AND FLAME-RETARDED POLYURETHANE FOAM CONTAINING THE SAME

(71) Applicant: DAIWA CHEMICAL INDUSTRIES CO., LTD., Osaka-shi, Osaka (JP)

(72) Inventors: Takashi NAKAMURA, Osaka-shi, Osaka (JP); Yusuke KAWAUCHI, Osaka-shi, Osaka (JP); Kentaro GOTO, Osaka-shi, Osaka (JP); Naoki MORIMOTO, Osaka-shi, Osaka (JP); Noriko GOTO, Osaka-shi, Osaka (JP)

(21) Appl. No.: 17/417,338

(22) PCT Filed: Apr. 1, 2020
(86) PCT No.: PCT/JP2020/015123

§ 371 Date: Jun. 22, 2021

(30) Foreign Application Priority Data
Apr. 1, 2019 (JP) 2019-070035
Feb. 28, 2020 (JP) 2020-034474
Apr. 1, 2020 (JP) 2020-066280

(51) Int. Cl. C08J 9/00; C08J 9/14; C08K 13/02

(52) U.S. Cl. CPC C08J 9/0095; C08J 9/0038; C08J 9/0066; C08J 9/146; C08K 13/02; C08K 5/523; C08J 2375/08; C08J 2205/06; C08J 2205/08; C08J 2203/162; C08J 2375/06

(57) ABSTRACT

An object is to provide a non-red phosphorus type flame retardant composition for polyurethane foam that does not undergo dripping ignition and readily forms a carbonized layer when the polyurethane foam is burned and a flame-retarded polyurethane foam containing the flame retardant composition for polyurethane foam. As a solution, a flame retardant composition for polyurethane foam having high carbonization properties, the flame retardant composition for polyurethane foam containing a phosphorus compound represented by formula (1), is provided.

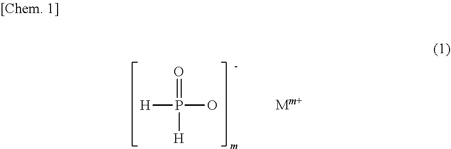

(In formula, M is Mg, Al, Ca, Ti, or Zn, and m is 2, 3, or 4.)

### TECHNICAL FIELD

The present invention relates to a flame retardant composition for polyurethane foam that contains no red phosphorus and a flame-retarded polyurethane foam containing the flame retardant composition for polyurethane foam. The flame retardant composition for polyurethane foam does not undergo melt dripping and readily forms a carbonized layer when burned.

The flame retardant according to the present invention can be used for polyurethane foam of any type, i.e., flexible, semi-rigid, and rigid.

### BACKGROUND ART

Polyurethane foam has been employed not only as sound absorbing materials, sound insulating materials, and heat insulating materials for automobiles and electrical appliances but also as heat insulation measures for detached houses, apartment houses, etc. in foam-in-place heat insulation construction methods in which polyurethane foam is sprayed on concrete members or inner wall material surfaces. However, a high flame retardancy standard such as UL-94V is required in the use for automobiles, electrical appliances, etc. In addition, in building uses, a fire occurring in a building may lead to a serious incident since the polyurethane foam itself is flammable, and one example of a test method assuming such a case is the cone calorimeter method. The flame retardancy standard in this case is also required to be very high flame retardancy exceeding UL-94V. Accordingly, various techniques have been developed to solve these problems.

For example, in building uses, spraying a refractory material made of a non-flammable inorganic coating material composed mainly of, for example, cement onto sprayed polyurethane foam is also performed. However, this method has a drawback in that since a refractory material is sprayed further onto polyurethane foam, two-stage spraying operation is required, and it is necessary to provide time to completion of curing reaction in each stage, leading to time-consuming construction and difficulty in construction schedule control.

As methods for improving the flame retardancy of polyurethane foam used as, for example, heat insulating materials for automobiles and electrical appliances, methods such as making the polyurethane foam itself flame retardant and imparting self-extinguishing properties to the polyurethane foam itself in case the polyurethane foam is burnt have also been attempted. Examples of such methods include incorporation of a flame retardant into polyurethane foam raw materials and introduction of a flame retardant component as a polyurethane foam constituent component through copolymerization.

Among the above-described methods for improving the flame retardancy of polyurethane foam, the incorporation of a flame retardant by addition is the mainstream method. This is because, for example, this method requires a low production cost, allows the type and amount of flame retardant to be freely adjusted in a post process during production, and is suitable for low-volume high-variety production.

Conventionally, phosphoric esters have been mainly used as flame retardants for polyurethane foam, but phosphoric esters have plasticizing effects and thus have the disadvantage of causing mechanical property degradation and shrinkage of polyurethane foam. Thus, there has been a need for reduction in the amount of phosphoric ester used and alternative flame retardants that do not adversely affect physical properties.

Examples of alternative flame retardants include red phosphorus, which has relatively high flame retardant properties. Actually, various methods of imparting flame retardancy using red phosphorus have been proposed. For example, PTL 1 discloses a flame retardant polyurethane resin composition containing a polyurethane resin, expandable graphite, polyphosphate or red phosphorus, and tricresyl phosphate.

PTL 2 discloses a flame retardant urethane resin composition containing red phosphorus as an essential component and further containing another flame retardant such as a phosphoric ester in combination.

Furthermore, hypophosphite is used as a flame retardant in a thermoplastic resin in some cases. In these cases, the flame retardancy due to, for example, an oxygen index is high to some extent, but it is not clear whether hypophosphite can be used also in a urethane resin, which is used in applications where higher flame retardancy is required unlike the thermoplastic resin.

PTL 3 discloses a thermoplastic polyamide composition containing a dialkyl phosphinate that is an aluminum organophosphinate. In this composition, the dialkyl phosphinate is selected and used with consideration for the stability of a thermoplastic polyamide melt.

### CITATION LIST

### Patent Literature

PTL 1: Japanese Unexamined Patent Application Publication No. 2005-133054

PTL 2: Japanese Unexamined Patent Application Publication No. 2017-075326

PTL 3: Japanese Unexamined Patent Application Publication No. 2018-511685

### SUMMARY OF INVENTION

### Technical Problem

However, while red phosphorus used in PTLs 1 and 2 has high flame retardant properties, it has a peculiar reddish tinge and thus may provide a product with undesired coloration. To achieve the balance between coloration suppression and flame retardant properties, a considerable amount of color removing agent needs to be incorporated, and this may cause problems such as degradation of flame retardant properties and poor light resistance of the color removing agent. Furthermore, red phosphorus is a flammable substance and how to handle red phosphorus is regulated by the Fire Service Act, and thus there is a safety concern about the use thereof.

The thermoplastic polyamide composition disclosed in PTL 3 solves the problem peculiar to flame retardant-containing thermoplastic polyamide compositions by selecting a particular aluminum organophosphinate and cannot be applied to resins other than thermoplastic polyamides.

The present invention has been made in view of the present circumstances described above, and an object of the present invention is to provide a flame retardant composition for polyurethane foam that contains no red phosphorus and a flame-retarded polyurethane foam containing the flame retardant composition for polyurethane foam. The flame retardant composition for polyurethane foam does not undergo melt dripping and readily forms a carbonized layer when burned and can exhibit high flame retardancy without containing red phosphorus. The biggest problem at present is that the above-described very high-level non-flammability standard of cone calorimeter testing cannot be satisfied if red phosphorus is not used, and there is a need for flame retardant compositions having high flame retardancy as alternatives to red phosphorus.

Furthermore, it is also desired to reduce the shrinkage and weight reduction after heating peculiar to polyurethane foam.

### Solution to Problem

To achieve the above object, the present inventors have conducted intensive studies and found that by using, as a flame retardant composition for polyurethane foam, a flame retardant composition containing a phosphorus compound represented by formula (1) below and optionally a concomitant flame retardant, a polyurethane foam that has high flame retardant properties, that is, has a low total heat release, a low maximum heat release rate, and a low weight reduction rate and exhibits small shrinkages in the width direction and the thickness direction and a small weight reduction after testing of the polyurethane foam, can be obtained. That is to say, the present inventors have found that by using the phosphorus compound of formula (1) below, a flame retardant composition for polyurethane foam that does not undergo melt dripping and readily forms a carbonized layer when burned and that can exhibit high flame retardancy without containing red phosphorus, and a flame-retarded polyurethane foam containing the flame retardant composition for polyurethane foam can be obtained, thereby completing the present invention.

Thus, the gist of the present invention is as follows.

(1) A flame retardant composition for polyurethane foam having high carbonization properties, the flame retardant composition containing

a phosphorus compound represented by formula (1) below, and

one or more concomitant flame retardants selected from the group consisting of melamine phosphate, melamine pyrophosphate, melamine polyphosphate, melamine phthalate, melamine, melamine cyanurate, ammonium polyphosphate, ammonium phosphate, zinc phosphate, non-halogenated phosphoric esters, halogenated phosphoric esters, bromine compounds, barium borate, borax, zinc borate, zinc stannate, magnesium hydroxide, aluminum hydroxide, antimony trioxide, antimony pentoxide, calcium molybdate, zinc molybdate, magnesium molybdate, magnesium silicate, hydrated gypsum, kaolin clay, mica, calcium carbonate, alunite, basic magnesium carbonate, calcium hydroxide, wollastonite, and inclusion compounds composed of zinc hydrogen phosphate having a zeolite structure and ethylenediamine,

the one or more concomitant flame retardants being contained in an amount of 0 to 600 parts by weight based on 100 parts by weight of the phosphorus compound represented by formula (1):

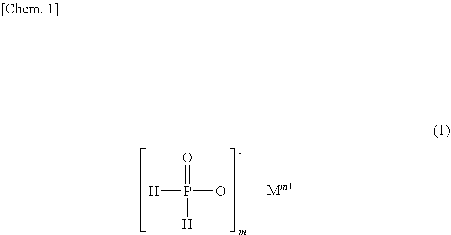

(in formula, M is Mg, Al, Ca, Ti, or Zn, and m is 2, 3, or 4).
(2) The flame retardant composition for polyurethane foam according to (1), wherein the phosphorus compound represented by formula (1) is a salt of Al, and

the one or more concomitant flame retardants are one or more flame retardants selected from the group consisting of melamine, melamine cyanurate, melamine phosphate, melamine polyphosphate, diammonium hydrogen phosphate, ammonium polyphosphate, magnesium hydroxide, aluminum hydroxide, zinc borate, zinc stannate, antimony trioxide, antimony pentoxide, non-halogenated phosphoric esters, halogenated phosphoric esters, decabromodiphenyl ethane, trisdibromoneopentyl phosphate, wollastonite, and inclusion compounds composed of zinc hydrogen phosphate having a zeolite structure and ethylenediamine.

(3) A flexible or semi-rigid flame-retarded polyurethane foam having high carbonization properties, containing the flame retardant composition for polyurethane foam according to (1) or (2), wherein the flexible or semi-rigid flame-retarded polyurethane foam does not undergo melt dripping and satisfies UL-94 V-0 performance.
(4) The flexible or semi-rigid flame-retarded polyurethane foam having high carbonization properties according to (3), wherein the flame retardant composition for polyurethane foam contains the phosphorus compound represented by formula (1) and one or more concomitant flame retardants selected from the group consisting of melamine, melamine cyanurate, melamine polyphosphate, ammonium polyphosphate, and zinc borate, and the one or more concomitant flame retardants are contained in an amount of 0 to 100 parts by weight based on 100 parts by weight of the phosphorus compound represented by formula (1).
(5) The flexible or semi-rigid flame-retarded polyurethane foam having high carbonization properties according to (3) or (4), not containing red phosphorus and/or an organic phosphinate.
(6) A rigid flame-retarded polyurethane foam having high carbonization properties, containing the flame retardant composition for polyurethane foam according to (1) or (2), wherein the rigid flame-retarded polyurethane foam satisfies performance such that when the polyurethane foam is heated at a radiant heat intensity of 50 kW/m² in cone calorimeter testing according to ISO-5660, a total heat release after 5 minutes is 10 MJ/m² or less, and a maximum heat release rate does not exceed 200 kW/m² for more than 10 seconds.
(7) The rigid flame-retarded polyurethane foam having high carbonization properties according to (6), wherein when the polyurethane foam is heated at a radiant heat intensity of 50 kW/m² in cone calorimeter testing according to ISO-5660, a total heat release after 20 minutes is 8 MJ/m² or less.
(8) The rigid flame-retarded polyurethane foam having high carbonization properties according to (6), wherein the flame retardant composition for polyurethane foam contains the phosphorus compound represented by formula (1) and a non-halogenated phosphoric ester and/or a halogenated phosphoric ester as the one or more concomitant flame retardants, and the one or more concomitant flame retardants are contained in an amount of 0 to 600 parts by weight based on 100 parts by weight of the phosphorus compound represented by formula (1).
(9) The rigid flame-retarded polyurethane foam having high carbonization properties according to (8), wherein the flame retardant composition for polyurethane foam further contains zinc borate as a concomitant flame retardant.
(10) The rigid flame-retarded polyurethane foam having high carbonization properties according to any one of (6) to (9), not containing red phosphorus and/or an organic phosphinate.
(11) The rigid flame-retarded polyurethane foam according to any one of (6) to (10), wherein the rigid flame-retarded polyurethane foam is formed by spray foaming.

### Advantageous Effects of Invention

According to the flame retardant composition for polyurethane foam according to the present invention, a flame retardant composition for polyurethane foam that does not undergo melt dripping and readily forms a carbonized layer when burned and that can exhibit high flame retardancy without containing red phosphorus and a flame-retarded polyurethane foam containing the flame retardant composition for polyurethane foam can be provided.

In particular, the flame retardant composition for polyurethane foam according to the present invention can provide a flexible or semi-rigid flame-retarded polyurethane foam that exhibits high carbonization properties when burned, that does not undergo melt dripping, and that meets the flame retardancy standard UL-94V-0. In addition, a rigid flame-retarded polyurethane foam can be provided that satisfies performance such that when the polyurethane foam is heated at a radiant heat intensity of 50 kW/m² in cone calorimeter testing according to ISO-5660, a total heat release after 5 minutes is 10 MJ/m² or less, and a maximum heat release rate does not exceed 200 kW/m² for more than 10 seconds.

Furthermore, the maximum heat release rate during heating peculiar to polyurethane foam can be smaller, and the total heat release, the amount of shrinkage, and the weight reduction rate can be lower when a polyurethane foam contains the phosphorus compound represented by formula (1) in the present invention than when it contains an organic phosphinate such as an aluminum organophosphinate.

### DESCRIPTION OF EMBODIMENTS

Hereinafter, an embodiment of a flame-retarded polyurethane foam according to the present invention will be described.

### [Flame Retardant (Formula (1) Below)]

A flame retardant used in the present invention is a compound represented by formula (1) below.

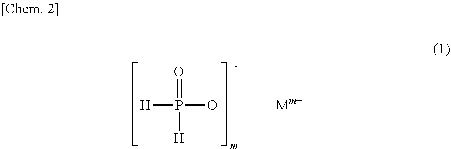

(In the formula, M is Mg, Al, Ca, Ti, or Zn, and m is 2, 3, or 4.)

M in formula (1) above is preferably Al.

Specific examples of the flame retardant represented by formula (1) above include zinc phosphinate, aluminum phosphinate, magnesium phosphinate, and calcium phosphinate.

These phosphorus compounds represented by formula (1) are typically in the form of colorless or white powder and thus can be used without inhibiting the colorability of products. Of these, the aluminum salt particularly produces beneficial effects in flame retardancy and carbonization properties.

The phosphorus compound represented by formula (1) above is obtained by reacting either phosphine acid or an alkali metal salt of phosphine acid with any one of nitrates, sulfates, carbonates, and hydroxides of water-soluble aluminum, zinc, magnesium, or calcium under heating in the state of an aqueous solution. This is an acid-base reaction or a salt reaction in the aqueous solution and is preferred in that the reaction rapidly proceeds to form a target compound in a relatively short time, for example, 1 to 3 hours.

The flame retardant composition according to the present invention may also contain, in addition to the phosphorus compound of formula (1), a concomitant flame retardant for further improvement in flame retardant properties. Specifically, one or more concomitant flame retardants selected from the group consisting of melamine phosphate, melamine pyrophosphate, melamine polyphosphate, melamine phthalate, melamine, melamine cyanurate, ammonium polyphosphate, ammonium phosphate, zinc phosphate, non-halogenated phosphoric esters, halogenated phosphoric esters, bromine compounds, barium borate, borax, zinc borate, zinc stannate, magnesium hydroxide, aluminum hydroxide, calcium hydroxide, antimony trioxide, antimony pentoxide, calcium molybdate, zinc molybdate, magnesium molybdate, magnesium silicate, hydrated gypsum, kaolin clay, mica, calcium carbonate, alunite, basic magnesium carbonate, wollastonite, and inclusion compounds composed of zinc hydrogen phosphate having a zeolite structure and ethylenediamine may be used.

The amount of these concomitant flame retardants is 0 to 600 parts by weight based on 100 parts by weight of the phosphorus compound represented by formula (1).

In particular, as a concomitant flame retardant for rigid polyurethane foam, it is preferable to employ a non-halogenated phosphoric ester and/or a halogenated phosphoric ester alone or a combination of a non-halogenated phosphoric ester and/or a halogenated phosphoric ester with another concomitant flame retardant.

When a combination of a non-halogenated phosphoric ester and/or a halogenated phosphoric ester with another concomitant flame retardant is employed, the amount of the other concomitant flame retardant is preferably 3 to 100 parts by weight, more preferably 5 to 90 parts by weight, still more preferably 15 to 75 parts by weight, based on 100 parts by weight of the phosphorus compound represented by formula (1).

Examples of non-halogenated phosphoric esters, halogenated phosphoric esters, and bromine compounds serving as the concomitant flame retardants include the following compounds.

The flame retardant composition according to the present invention does not contain red phosphorus and/or an organic phosphinate. As used herein, “not contain” refers to not containing such an amount that produces a flame-retardant effect or not containing at all.

### Non-Halogenated Phosphoric Esters

Trimethyl phosphate, triethyl phosphate, tributyl phosphate, tri(2-ethylhexyl) phosphate, tributoxyethyl phosphate, triphenyl phosphate, tricresyl phosphate, trixylenyl phosphate, tris(isopropylphenyl) phosphate, tris(phenylphenyl) phosphate, trinaphthyl phosphate, cresyl diphenyl phosphate, xylenyl diphenyl phosphate, resorcinol bis(diphenyl) phosphate, bisphenol A-bis(diphenyl) phosphate, bisphenol A-bis(dicresyl) phosphate, etc.

### Halogenated Phosphoric Esters

Tris(chloroethyl) phosphate, tris(β-chloropropyl) phosphate, tris(dichloropropyl) phosphate, tetrakis(2-chloroethyl) dichloroisopentyl diphosphate, polyoxyalkylene bis(dichloroalkyl) phosphate, poly[oxy[(2-chloro-1-methylethoxy)phosphinylidene]oxy-1,2-ethanediyloxy-1,2-ethanediyl], α-(2-chloro-1-methylethyl)-ω-[[bis(2-chloro-1-methylethoxy)phosphinyl]oxy], etc.

### Bromine Compounds

Hexabromobenzene, pentabromotoluene, decabromodiphenyl ethane, tetrabromobisphenol A, dibromoneopentyl glycol, tribromoneopentyl alcohol, trisdibromoneopentyl phosphate, etc.

Among combinations of the phosphorus compound of formula (1) with a concomitant flame retardant, combinations of an aluminum salt with one or more concomitant flame retardants selected from the group consisting of melamine, melamine cyanurate, melamine phosphate, melamine polyphosphate, diammonium hydrogen phosphate, ammonium polyphosphate, magnesium hydroxide, aluminum hydroxide, zinc borate, zinc stannate, antimony trioxide, antimony pentoxide, non-halogenated phosphoric esters, halogenated phosphoric esters, decabromodiphenyl ethane, trisdibromoneopentyl phosphate, wollastonite, and inclusion compounds composed of zinc hydrogen phosphate having a zeolite structure and ethylenediamine are preferred.

Among these concomitant flame retardants, one or more concomitant flame retardants selected from the group consisting of melamine, melamine cyanurate, melamine phosphate, zinc borate, magnesium hydroxide, aluminum hydroxide, antimony trioxide, non-halogenated phosphoric esters, halogenated phosphoric esters, decabromodiphenyl ethane, and inclusion compounds composed of zinc hydrogen phosphate having a zeolite structure and ethylenediamine are more preferred.

For the blending ratio of the phosphorus compound of formula (1) and the concomitant flame retardants, the total amount of the one or more compounds that are concomitant flame retardants is preferably 0 to 600 parts by weight, more preferably 0 to 400 parts by weight, based on 100 parts by weight of the phosphorus compound of formula (1) of the present invention.

The amount of addition of the flame retardant composition in the polyurethane foam according to the present invention is in the range of 2 to 200 parts by weight, particular preferably in the range of 10 to 150 parts by weight, based on 100 parts by weight of a polyol. If the amount of addition is more than 200 parts by weight, the foamability of the polyurethane foam may be inhibited, and if the amount of addition is less than 2 parts by weight, sufficient flame retardant properties may not be provided.

### [Flame-Retarded Polyurethane Foam]

The flame-retarded polyurethane foam according to the present invention is produced by foaming a polyurethane foam blend containing, as essential raw materials, a polyol, an isocyanate, a catalyst, a foaming agent, and a flame retardant and further containing a crosslinking agent, a foam stabilizer, and other additives as required. These components will be described below.

### [Flame Retardant Composition]

The flame retardant composition used in the present invention contains the phosphorus compound of formula (1) as an essential component and may further contain a concomitant flame retardant as required. When a concomitant flame retardant is contained, their blending ratio is such that the amount of the concomitant flame retardant is 0 to 600 parts by weight based on 100 parts by weight of the phosphorus compound of formula (1).

As the phosphorus compound of formula (1), a salt of Mg, Al, Ca, Ti, or Zn can be used. As the concomitant flame retardant, one or more selected from the group consisting of melamine phosphate, melamine pyrophosphate, melamine polyphosphate, melamine phthalate, melamine, melamine cyanurate, ammonium polyphosphate, ammonium phosphate, zinc phosphate, non-halogenated phosphoric esters, halogenated phosphoric esters, bromine compounds, barium borate, borax, zinc borate, zinc stannate, magnesium hydroxide, aluminum hydroxide, antimony trioxide, antimony pentoxide, calcium molybdate, zinc molybdate, magnesium molybdate, magnesium silicate, hydrated gypsum, kaolin clay, mica, calcium carbonate, alunite, basic magnesium carbonate, calcium hydroxide, wollastonite, and inclusion compounds composed of zinc hydrogen phosphate having a zeolite structure and ethylenediamine can be used.

For the combination of the phosphorus compound of formula (1) with a concomitant flame retardant, most preferred flame retardant properties are exhibited when an aluminum salt is selected as the phosphorus compound of formula (1) and one or more selected from the group consisting of melamine, melamine cyanurate, melamine phosphate, melamine polyphosphate, diammonium hydrogen phosphate, ammonium polyphosphate, magnesium hydroxide, aluminum hydroxide, zinc borate, zinc stannate, antimony trioxide, antimony pentoxide, non-halogenated phosphoric esters, halogenated phosphoric esters, decabromodiphenyl ethane, trisdibromoneopentyl phosphate, wollastonite, and inclusion compounds composed of zinc hydrogen phosphate having a zeolite structure and ethylenediamine are selected as the concomitant flame retardant.

For a flexible or semi-rigid flame-retarded urethane foam, high flame retardant properties are exhibited even when the phosphorus compound of formula (1) is used alone, and, furthermore, preferred flame retardant properties are exhibited also when melamine, melamine cyanurate, melamine polyphosphate, ammonium polyphosphate, or zinc borate is used as a concomitant flame retardant in combination.

For a rigid flame-retarded urethane foam, preferred flame retardant properties are exhibited when a non-halogenated phosphoric ester and/or a halogenated phosphoric ester is used as a concomitant flame retardant in combination with the phosphorus compound of formula (1), and preferred flame retardant properties are exhibited also when zinc borate is used as another flame retardant in combination with a non-halogenated phosphoric ester and/or a halogenated phosphoric ester.

### [Polyol]

The polyol in the present invention is not particularly limited, and any polyol used as a raw material polyol for typical polyurethane foam, such as polyether polyol, polyester polyol, or phenolic polyol, can be suitably used. A polyester polyol can be used alone, or a polyester polyol and a polyether polyol can be used in combination. Examples of polyester polyols include polyester polyols derived from polyhydric alcohol-polycarboxylic acid condensates and polyester polyols derived from ring-opened polymers of cyclic esters. In this case, examples of polyhydric alcohols include ethylene glycol, propylene glycol, diethylene glycol, dipropylene glycol, butanediol, hexanediol, trimethylolpropane, and methylpropanediol, and examples of carboxylic acids include succinic acid, adipic acid, sebacic acid, maleic acid, phthalic anhydride, isophthalic acid, and terephthalic acid. Examples of ring-opened polymers include polyester polyols obtained by ring-opening of ε-caprolactone and addition polymerization with glycol.

### [Isocyanate]

As the isocyanate used in the present invention, a compound having at least two isocyanate groups can be used. Examples include, but are not limited to, tolylene diisocyanate (TDI), diphenylmethane diisocyanate (MDI), triphenyl diisocyanate, polymethylene polyphenyl polyisocyanate, hexamethylene diisocyanate, and isophorone diisocyanate.

### [Catalyst]

As the catalyst, a catalyst known to be usable for polyurethane foam can be used. Examples include amine catalysts such as triethylamine, triethylenediamine, diethanolamine, dimethylaminomorpholine, N-ethylmorpholine, N,N-dimethylcyclohexylamine, and tetramethylguanidine; tin catalysts such as stannous octoate and dibutyltin dilaurate; nitrogen-containing aromatic compounds such as tris(dimethylaminomethyl) phenol, 2,4-bis(dimethylaminomethyl) phenol, and 2,4,6-tris(dialkylaminoalkyl)hexahydro-S-triazine; carboxylic acid alkali metal salts such as potassium acetate, potassium 2-ethylhexanoate, and potassium octoate; tertiary ammonium salts such as trimethylammonium salts, triethylammonium salts, and triphenylammonium salts; and quaternary ammonium salts such as tetramethylammonium salts, tetraethylammonium, and tetraphenylammonium salts. These catalysts can be used alone or in combination of two or more. The amount of catalyst used is preferably 0.1 to 10 parts by weight based on 100 parts by weight of the polyol.

### [Foaming Agent]

Examples of foaming agents that can be used include water; organic physical foaming agents including low-boiling hydrocarbons such as propane and butane, chlorinated aliphatic hydrocarbon compounds such as dichloroethane and butyl chloride, fluorine compounds such as trichloromonofluoromethane, trichlorofluoroethane, and hydrofluoroolefins (HFO) such as trans-1-chloro-3,3,3-trifluoropropene, hydrochlorofluorocarbon compounds such as dichloromonofluoroethane, chlorodifluoromethane, and 1-chloro-1,1-difluoroethane, hydrofluorocarbon compounds such as 1,1,1,3,3-pentafluoropropane and 1,1,1,3,3-pentafluorobutane, ether compounds such as diisopropyl ether, and mixtures of these compounds; and inorganic physical foaming agents such as nitrogen gas, oxygen gas, argon gas, and carbon dioxide gas. These foaming agents can be used alone or in combination of two or more. The amount of these foaming agents used is preferably 1 to 40 parts by weight based on 100 parts by weight of the polyol.

### [Other Additives]

The resin composition for polyurethane foam according to the present invention may optionally contain, as components other than the polyol component, the polyisocyanate component, the flame retardant, the concomitant flame retardant, the catalyst, and the foaming agent described above, various components such as a foam stabilizer, a crosslinking agent, a foaming assistant, a dehydrator, a plasticizer, a weathering agent, a colorant, and a filler in such an amount that the advantageous effects of the present invention are not impaired. These various components may be added in advance to the polyol component or the polyisocyanate component or may be added when the polyol component and the polyisocyanate component are mixed together.

The foam stabilizer may be, for example, a commercially available foam stabilizer used in the production of polyurethane foam. For example, the foam stabilizer may be, but not necessarily, a surfactant, and examples of surfactants include organic silicone surfactants such as nonionic surfactants including organic siloxane-polyoxyalkylene copolymers and silicone-grease copolymers. The amount of foam stabilizer made of such a silicone compound is preferably 0.5 parts by weight or more based on 100 parts by weight of the polyol.

### [Production of Flame-Retarded Polyurethane Foam]

The method for producing the polyurethane foam containing the flame retardant composition according to the present invention is not particularly limited, and a commonly used method can be used.

Specifically, the polyurethane foam can be produced by a known foaming method in which polyurethane foam raw materials including the polyol, the isocyanate, the catalyst, the foaming agent, the foam stabilizer, and the flame retardant described above are mixed under stirring and allowed to react.

Examples of the foaming method include slab foaming and mold foaming, and either formation method may be used. Slab foaming is a method in which a mixture of polyurethane foam raw materials is discharged onto a belt conveyor and foamed under atmospheric pressure at normal temperature (20±15° C.) On the other hand, mold foaming is a method in which a mixture of foam raw materials is injected into a mold (forming die) and foamed in the mold. These foaming methods are production methods intended for polyurethane foam referred to as flexible or semi-rigid polyurethane foam.

One of the foaming methods other than the above is a foam-in-place method, and foamed-in-place polyurethane foam is what is called rigid polyurethane foam produced by foaming a resin composition for polyurethane foam by machine or hand at a formation site. This method employs spray foaming and is specifically a polyurethane foam forming method in which the resin composition for polyurethane foam is discharged in a mist using a foaming machine and directly sprayed onto a target, whereby foam molding of polyurethane foam and adhesion of the polyurethane foam to the target are simultaneously performed.

Since it is difficult to control the temperature in foam-in-place spray foaming, a resin composition for polyurethane foam that has low viscosity at normal temperature (20±15° C.) and is easy to handle is preferably used. This method is a production method intended for polyurethane foam generally referred to as rigid polyurethane foam.

For the density of the flame-retarded polyurethane foam according to the present invention, in the case of rigid flame-retarded polyurethane foam, the density is 30 to 120 kg/m³, more preferably 40 to 90 kg/m³, and in the case of flexible or semi-rigid flame-retarded polyurethane foam, the density is preferably 10 to 70 kg/m³, more preferably 20 to 60 kg/m³.

The flame retardant composition according to the present invention can be used for polyurethane foam of any type, i.e., rigid, semi-rigid, and flexible. The use of the resulting flame-retarded polyurethane foam is not limited to sound absorbing materials, sound insulating materials, vibration damping materials for automobiles and heat insulating materials for construction. The flame-retarded polyurethane foam can also be used for, for example, seat cushions, floor carpets, ceiling materials, engine filters, oil filters, and insulators used as heat insulating materials or interior materials for vehicles, trains, aircraft, and ships; cushioning materials for furniture; electrical and electronic materials (for filling spaces in distributing cable boxes, pipe penetrating sections, etc.); packaging materials; and shock absorbing materials.

### Examples

Hereinafter, the present invention will be described more specifically with reference to Examples and Comparative Examples, but the following Examples are not intended to limit the technical scope of the present invention. In the following Examples, “%” means wt %, and “parts” means parts by weight, unless otherwise specified. The evaluation of flame-retarded polyurethane foams was performed by the following methods.

### [Evaluation of Flame Retardancy and Other Properties]

### (Preparation of Sample)

A rigid polyurethane foam and a flexible polyurethane foam were produced by the following method and subjected to tests of flame retardancy and other properties.

### Method of Preparing Rigid Polyurethane Foam Sample

A polyol compound, a foam stabilizer, an amine catalyst, and a polymerization catalyst were weighed into a 1000 mL polypropylene beaker and stirred at 20° C. for 30 seconds with a stirrer.

A flame retardant component was added to the stirred mixture and mixed with a stirrer. Next, foaming agents such as water and HFO were added and mixed. Lastly, an organic isocyanate (COSMONATE M-200) was added and vigorously stirred for about 10 seconds to prepare a foamed body having a density of 60 kg/m³.

### Method of Preparing Flexible Polyurethane Foam Sample

A polyol compound, water serving as a foaming agent, a catalyst, a foam stabilizer, and optional other additives were placed into a 1000 mL polypropylene beaker and stirred at 25° C. for 30 seconds with a stirrer.

A flame retardant component was added to the stirred mixture and mixed with a stirrer. Lastly, an organic isocyanate (MILLIONATE MR-200) was added and vigorously stirred for about 10 seconds to prepare a foamed body having a density of 29 kg/m³.

### (Evaluation Method)

### Rigid Polyurethane Foam

### Cone Calorimeter Test

From the rigid polyurethane foam prepared in the above manner, a sample for cone calorimeter testing was cut out to be 10 cm×10 cm×5 cm. In accordance with ISO-5660, the total heat release, 200 kW/m² exceeding time, and maximum heat release rate of the sample were measured when the sample was heated at a radiant heat intensity of 50 kW/m² for 5 minutes, 10 minutes, and 20 minutes.

This measurement method is a test method prescribed as meeting the standard according to the cone calorimeter method by General Building Research Corporation, which is a public institution specified in Building Standard Law Enforcement Order, Article 108-2.

### (Measurement of Density)

The above sample for cone calorimeter testing was measured for size using vernier calipers and measured for mass using an electronic balance, and a density was calculated from the measured values obtained.

### (Evaluation of State of Residue)

The sample subjected to the above test according to ISO-5660 was visually observed. When a crack or hole extending through the sample to the back side was observed, the sample was evaluated as “present”, and when deformation reaching the back side was not observed, the sample was evaluated as “absent”.

### (Measurement of Shrinkage)

After the above test according to ISO-5660 was performed, the magnitude of changes relative to the original size of the sample, i.e., a change from the width of 10 cm and a change from the thickness of 5 cm, was measured. Swelling was expressed using “+”, and shrinkage was expressed using “−”.

When a fire breaks out, if the shrinkage or the swelling is large, it may be possible that breakage or separation from a wall surface occurs to cause continuation of burning. Thus, both the swelling and the shrinkage are preferably small.

### (Weight Reduction)

The mass of the sample before and after the above test according to ISO-5660 was performed was measured with an electronic balance, and a weight reduction rate was calculated from the measured values obtained.

### Flexible Polyurethane Foam

### UL-94V Test

From the flexible polyurethane foam prepared in the above manner, a test piece 127 mm long×12.7 mm wide×3.0 mm thick was prepared. A vertical flame test was performed in accordance with the UL-94V standard.

The highest rank is V-0, and the flame retardancy decreases as the number increases to V-1 and V-2. Samples not falling into any of the ranks from V-0 to V-2 were ranked as NC.

### (Evaluation Results)

For the flame retardant property test of the rigid polyurethane foam, the results of the above evaluations of Examples and Comparative Examples are shown in Table 1 and Table 2.

Furthermore, the criteria of the evaluation in Table 2 on the basis of the above cone calorimeter test are as follows.

Non-flammable: The total heat release after heating for 20 minutes is 8.0 MJ/m² or less.

Quasi-non-flammable: The total heat release after heating for 10 minutes is 8.0 MJ/m² or less.

Flame-retardant: The total heat release after heating for 5 minutes is 8.0 MJ/m² or less.

TABLE 1-1

| | | Example | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Polyester polyol | | 100 | 100 | 100 | 100 | 100 | 100 | 100 | 100 | 100 | 100 | 100 | 100 |
| Polyether polyol | | | | | | | | | | | | | |
| Phthalic acid polyol | | | | | | | | | | | | | |
| Silicone foam stabilizer | | 3 | 3 | 3 | 3 | 3 | 3 | 3 | 3 | 3 | 3 | 3 | 3 |
| Amine catalyst | | 1.5 | 1.5 | 1.5 | 1.5 | 1.5 | 1.5 | 1.5 | 1.5 | 2 | 2 | 1.5 | 1.5 |
| Polymerization catalyst (13%) | | 6 | 6 | 6 | 6 | 6 | 6 | 6 | 6 | 6 | 6 | 6 | 6 |
| Phosphorus compound of | | 30 | 30 | 30 | 30 | 30 | 30 | 30 | 30 | 30 | 30 | 30 | 30 |
| formula (1) M = Al | | | | | | | | | | | | | |
| TMCPP | | 100 | 100 | 100 | 100 | 100 | 100 | 100 | 100 | 100 | 100 | 100 | 100 |
| Polyoxyalkylene | | | | | | | | | | | | | |
| bis(dichloroalkyl) phosphate | | | | | | | | | | | | | |
| Tris(dichloropropyl) phosphate | | | | | | | | | | | | | |
| Zinc borate | | | 15 | | | | | | | | | | |
| Zinc stannate | | | | 15 | | | | | | | | | |
| Magnesium hydroxide | | | | | 15 | | | | | | | | |
| Aluminum hydroxide | | | | | | 15 | | | | | | | |
| Zinc molybdate | | | | | | | 15 | | | | | | |
| Melamine phosphate | | | | | | | | 15 | | | | | |
| Melamine polyphosphate | | | | | | | | | 15 | | | | |
| Diammonium phosphate | | | | | | | | | | 15 | | | |
| Ammonium polyphosphate | | | | | | | | | | | 15 | | |
| Decabromodiphenyl ethane | | | | | | | | | | | | 7.5 | 7.5 |
| Trisdibromoneopentyl | | | | | | | | | | | | | |
| phosphate | | | | | | | | | | | | | |
| Antimony trioxide | | | | | | | | | | | | 2.5 | |
| Antimony pentoxide | | | | | | | | | | | | | 4 |
| Wollastonite | | | | | | | | | | | | | |
| Red phosphorus | | | | | | | | | | | | | |
| Water | | 5 | 5 | 5 | 5 | 5 | 5 | 5 | 5 | 5 | 5 | 5 | 5 |
| HFO | | 25 | 25 | 25 | 25 | 25 | 25 | 25 | 25 | 25 | 25 | 25 | 25 |
| Polymethylene polyphenyl | | 270 | 270 | 270 | 270 | 270 | 270 | 270 | 270 | 270 | 270 | 270 | 270 |
| polyisocyanate | | | | | | | | | | | | | |
| INDEX | | 3 | 3 | 3 | 3 | 3 | 3 | 3 | 3 | 3 | 3 | 3 | 3 |
| Density kg/m³ | | 60 | 65 | 59 | 61 | 65 | 64 | 64 | 65 | 61 | 60 | 60 | 62 |
| Results | Total heat release after | 7.8 | 5.2 | 6.7 | 6.5 | 6.9 | 5.9 | 6.8 | 6.8 | 8.5 | 7.9 | 7 | 7 |
| | 5 minutes (MJ/m²) | | | | | | | | | | | | |
| | 200 kW/m² exceeding | 0 | 0 | 0 | 0 | 0 | 0 | 0 | 0 | 0 | 0 | 0 | 0 |
| | time (sec) | | | | | | | | | | | | |
| | Maximum heat release | 69 | 63 | 70 | 69 | 62 | 65 | 63 | 70 | 71 | 68 | 62 | 72 |
| | rate (kW/m²) | | | | | | | | | | | | |

TABLE 1-2

| | | Example | | | | | | Comparative Example | | | | | |
|---|---|---|---|---|---|---|---|---|---|---|---|---|---|
| | | 13 | 14 | 15 | 16 | 17 | 18 | 1 | 2 | 3 | 4 | 5 | 6 |
| Polyester polyol | | 100 | 100 | 100 | 100 | | | 100 | 100 | 100 | 100 | 100 | 100 |
| Polyether polyol | | | | | | 100 | | | | | | | |
| Phthalic acid polyol | | | | | | | 100 | | | | | | |
| Silicone foam stabilizer | | 3 | 3 | 3 | 3 | 3 | 3 | 3 | 3 | 3 | 3 | 3 | 3 |
| Amine catalyst | | 1.5 | 1.5 | 1.5 | 1.5 | 1.5 | 1.5 | 1.5 | 1.5 | 1.5 | 1.5 | 1.5 | 1.5 |
| Polymerization catalyst (13%) | | 6 | 6 | 6 | 6 | 6 | 6 | 6 | 6 | 6 | 6 | 6 | 2 |
| Phosphorus compound of | | 30 | 30 | 30 | 30 | 30 | 30 | | | | | | |
| formula (1) M = Al | | | | | | | | | | | | | |
| TMCPP | | 100 | 100 | | | 100 | 100 | 100 | 100 | 100 | 100 | 100 | 100 |
| Polyoxyalkylene | | | | 100 | | | | | | | | | |
| bis(dichloroalkyl) phosphate | | | | | | | | | | | | | |
| Tris(dichloropropyl) phosphate | | | | | 100 | | | | | | | | |
| Zinc borate | | | | 15 | 15 | 15 | 15 | | 15 | | | | |
| Zinc stannate | | | | | | | | | | | | | |
| Magnesium hydroxide | | | | | | | | | | | | | |
| Aluminum hydroxide | | | | | | | | | | 15 | | | |
| Zinc molybdate | | | | | | | | | | | | | |
| Melamine phosphate | | | | | | | | | | | | | |
| Melamine polyphosphate | | | | | | | | | | | 15 | | |
| Diammonium phosphate | | | | | | | | | | | | | |
| Ammonium polyphosphate | | | | | | | | | | | | | |
| Decabromodiphenyl ethane | | | | | | | | | | | | | |
| Trisdibromoneopentyl | | 10 | | | | | | | | | | 10 | |
| phosphate | | | | | | | | | | | | | |
| Antimony trioxide | | | | | | | | | | | | | |
| Antimony pentoxide | | | | | | | | | | | | | |
| Wollastonite | | | 15 | | | | | | | | | | |
| Red phosphorus | | | | | | | | | | | | | 30 |
| Water | | 5 | 5 | 5 | 5 | 5 | 5 | 5 | 5 | 5 | 5 | 5 | 5 |
| HFO | | 25 | 25 | 25 | 25 | 25 | 25 | 25 | 25 | 25 | 25 | 25 | 25 |
| Polymethylene polyphenyl | | 270 | 270 | 270 | 270 | 315 | 320 | 270 | 270 | 270 | 270 | 270 | 270 |
| polyisocyanate | | | | | | | | | | | | | |
| INDEX | | 3 | 3 | 3 | 3 | 3 | 3 | 3 | 3 | 3 | 3 | 3 | 3 |
| Density kg/m³ | | 60 | 58 | 66 | 65 | 54 | 62 | 54 | 59 | 62 | 61 | 65 | 53 |
| Results | Total heat release after | 7.1 | 7.7 | 5.9 | 6 | 7.9 | 5.3 | 12.5 | 13.2 | 17 | 15.3 | 13.9 | 11 |
| | 5 minutes (MJ/m²) | | | | | | | | | | | | |
| | 200 kW/m² exceeding | 0 | 0 | 0 | 0 | 0 | 0 | 0 | 0 | 0 | 0 | 0 | 0 |
| | time (sec) | | | | | | | | | | | | |
| | Maximum heat release | 70 | 78 | 64 | 68 | 70 | 61 | 110 | 102 | 121 | 89 | 120 | 74 |
| | rate (kW/m²) | | | | | | | | | | | | |

TABLE 2

| | | | | | | | | | | Comparative | |
|---|---|---|---|---|---|---|---|---|---|---|---|
| | | Example | | | | | | | | Example | |
| | | 19 | 20 | 21 | 22 | 23 | 24 | 25 | 26 | 7 | 8 |
| Polyester polyol | | 100 | 100 | 80 | 100 | 100 | 100 | 100 | 100 | 100 | 100 |
| Polyether polyol | | | | 20 | | | | | | | |
| Silicone foam stabilizer | | 3 | 3 | 3 | 3 | 3 | 3 | 3 | 3 | 3 | 3 |
| Amine catalyst | | 8 | 8 | 8 | 8 | 8 | 8 | 8 | 8 | 8 | 8 |
| Polymerization catalyst (10%) | | 8 | 8 | 8 | 8 | 8 | 8 | 8 | 8 | 8 | 8 |
| Phosphorus compound of | | 26 | 26 | 26 | 26 | 26 | 26 | 26 | 26 | | |
| formula (1) M = Al | | | | | | | | | | | |
| Aluminum tris(diethyl | | | | | | | | | | 40 | 26 |
| phosphinate) | | | | | | | | | | | |
| TMCPP | | 120 | 120 | 120 | 120 | 120 | 120 | | | 120 | 120 |
| Cresyl diphenyl phosphate | | | | | | | | 120 | | | |
| Resorcinol bis(diphenyl) | | | | | | | | | 120 | | |
| phosphate | | | | | | | | | | | |
| Zinc borate | | 14 | 14 | 14 | 14 | 14 | 14 | 14 | 14 | | 14 |
| Aluminum hydroxide | | | | | 5 | | | | | | |
| Antimony trioxide | | | | | | 5 | | | | | |
| Zinc hydrogen phosphate | | | | | | | 5 | | | | |
| Water | | 3 | 4 | 3 | 3 | 3 | 3 | 3 | 3 | 3 | 3 |
| HFO-1233zdE | | 20 | 35 | 20 | 20 | 20 | 20 | 20 | 20 | 20 | 20 |
| Polymethylene polyphenyl | | 300 | 350 | 310 | 300 | 300 | 300 | 300 | 300 | 300 | 300 |
| polyisocyanate | | | | | | | | | | | |
| INDEX | | 300 | 300 | 300 | 300 | 300 | 300 | 3 | 3 | 300 | 300 |
| Density kg/m³ | | 49.0 | 40.8 | 45.2 | 47.1 | 49.0 | 46.6 | 43.5 | 47.2 | 51.0 | 53.0 |
| Results | Heat release after | 4.3 | 5.2 | 5.3 | 4.2 | 3.8 | 3.2 | 3.9 | 4.2 | 5.8 | 7.3 |
| | 5 minutes (MJ/m²) | | | | | | | | | | |
| | Heat release after | 5.3 | 6.0 | 6.4 | 5.4 | 4.9 | 4.3 | 4.4 | 4.7 | 8.9 | 11.1 |
| | 10 minutes (MJ/m²) | | | | | | | | | | |
| | Heat release after | 6.3 | 7.5 | 7.8 | 6.4 | 6.1 | 5.9 | 5.9 | 7.2 | 11.7 | 14.0 |
| | 20 minutes (MJ/m²) | | | | | | | | | | |
| | 200 kW exceeding | 0.0 | 0.0 | 0.0 | 0.0 | 0.0 | 0.0 | 0.0 | 0.0 | 0.0 | 0.0 |
| | time sec | | | | | | | | | | |
| | Maximum heat | 41.3 | 49.1 | 50.8 | 46.3 | 40.2 | 38.9 | 46.5 | 51.3 | 65.2 | 51.9 |
| | release rate | | | | | | | | | | |
| | (kW/m²) | | | | | | | | | | |
| | Through crack or | absent | absent | absent | absent | absent | absent | absent | absent | absent | absent |
| | hole | | | | | | | | | | |
| | Shrinkage after | −0.6 | −0.7 | −0.5 | −0.7 | −0.9 | −0.3 | −0.7 | −0.5 | −1.5 | −1.6 |
| | testing (cm) | | | | | | | | | | |
| | (width direction) | | | | | | | | | | |
| | Shrinkage after | +0.1 | −0.7 | −0.2 | −0.3 | +0.1 | +0.2 | −0.4 | −0.4 | −1.0 | −1.0 |
| | testing (cm) | | | | | | | | | | |
| | (thickness | | | | | | | | | | |
| | direction) | | | | | | | | | | |
| | Weight reduction | −38.0 | −31.6 | −37.9 | −39.4 | −36.2 | −35.8 | −41.4 | −35.3 | −51.3 | −52.0 |
| | rate (%) | | | | | | | | | | |
| | Evaluation | non- | non- | non- | non- | non- | non- | non- | non- | flame- | flame- |
| | | flammable | flammable | flammable | flammable | flammable | flammable | flammable | flammable | retardant | retardant |

Polyester polyol; ACTCOL ES-258N (Mitsui Chemicals & SKC Polyurethanes Inc.)
Polyether polyol; ACTCOL T-700S (Mitsui Chemicals & SKC Polyurethanes Inc.)
Phthalic acid polyol; MAXIMOL RFK-505 (Kawasaki Kasei Chemicals Ltd.)
Silicone foam stabilizer; NIAX L-6620 (MOMENTIVE)
Amine catalyst; N,N-dimethylcyclohexylamine
Polymerization catalyst (13%); potassium octoate TMCPP; tris(fβ-chloropropyl) phosphate (Daihachi Chemical Industry Co., Ltd.)
Polyoxyalkylene bis(dichloroalkyl) phosphate; CR-504L (Daihachi Chemical Industry Co., Ltd.)
Tris(dichloropropyl) phosphate; tris(dichloropropyl) phosphate (Tokyo Chemical Industry Co., Ltd.)
Cresyl diphenyl phosphate; CDP (Daihachi Chemical Industry Co., Ltd.)
Resorcinol bis(diphenyl) phosphate; CR-733S (Daihachi Chemical Industry Co., Ltd.)
Zinc borate; ZB2335 (Kinsei Matec Co., Ltd.)
Zinc stannate; ZHS (Kinsei Matec Co., Ltd.)
Magnesium hydroxide; KISUMA 5A (Kyowa Chemical Industry Co., Ltd.)
Aluminum hydroxide; HIGILITE H-32 (Showa Denko K.K.)
Zinc molybdate; zinc molybdate (Kojundo Chemical Lab. Co., Ltd.)
Melamine phosphate; BUDIT310 (CBC Co., Ltd.)
Melamine polyphosphate; BUDIT3141 (CBC Co., Ltd.)
Diammonium phosphate; diammonium hydrogen phosphate (Taihei Chemical Industrial Co., Ltd.)
Ammonium polyphosphate; FR CROS484 (CBC Co., Ltd.)
Aluminum tris(diethyl phosphinate) (aluminum organophosphinate); EXOLIT OP930 (Clariant Chemicals Co., Ltd.)
Decabromodiphenyl ethane; SAYTEX8010 (Albemarle Japan Corporation)
Trisdibromoneopentyl phosphate; CR-900 (Daihachi Chemical Industry Co., Ltd.)
Antimony trioxide; antimony trioxide (Suzuhiro Chemical Co., Ltd.)
Antimony pentoxide; BurnEx 30-107 (NYACOL Nano Technologies, Inc.)

### Wollastonite; SH-400 (Kinsei Matec Co., Ltd.)

Zinc hydrogen phosphate; Fire Cut ZPO-3 (Suzuhiro Chemical Co., Ltd.), an inclusion compound composed of zinc hydrogen phosphate having a zeolite structure and ethylenediamine Red phosphorus; NOVA EXCEL 140 (Rin Kagaku Sangyo Co., Ltd.) HFO; HFO-1233zdE (Honeywell Japan Ltd.)
Polymethylene polyphenyl polyisocyanate; COSMONATE M-200 (Mitsui Chemicals & SKC Polyurethanes Inc.)

INDEX in Tables 1-1 and 1-2 is defined as (the number of equivalents of polyisocyanate)÷(the number of equivalents of polyol+the number of equivalents of water). The number of equivalents of polyol compound is expressed as [hydroxyl value (mgKOH/g) of polyol compound]×[weight (g) of polyol compound]÷[molecular weight of potassium hydroxide]. The number of equivalents of polyisocyanate is expressed as [molecular weight of polyisocyanate group]×100÷[wt % of isocyanate group], and the number of equivalents of water is expressed as [weight (g) of water]×2÷[molecular weight of water].

For the flame retardant property test of the flexible polyurethane foam, the evaluation results of Examples and Comparative Examples are shown in Table 3.

TABLE 3

| | | | | | | | Comparative |
|---|---|---|---|---|---|---|---|
| | Example | | | | | | Example |
| | 27 | 28 | 29 | 30 | 31 | 32 | 9 |
| Polyether polyol | 100 | 100 | 100 | 100 | 100 | 100 | 100 |
| Water | 4 | 4 | 4 | 4 | 4 | 4 | 4 |
| Triethylenediamine | 0.3 | 0.3 | 0.3 | 0.3 | 0.3 | 0.3 | 0.3 |
| Stannous octoate | 0.3 | 0.3 | 0.3 | 0.3 | 0.3 | 0.3 | 0.3 |
| Silicone foam stabilizer | 1.5 | 1.5 | 1.5 | 1.5 | 1.5 | 1.5 | 1.5 |
| Phosphorus compound of | 20 | 14 | 14 | 14 | 14 | 14 | |
| formula (1)M = Al | | | | | | | |
| Melamine cyanurate | | 6 | | | | | |
| Melamine | | | 6 | | | | |
| Melamine polyphosphate | | | | 6 | | | |
| Ammonium polyphosphate | | | | | 6 | | |
| Zinc borate | | | | | | 6 | |
| TMCPP | | | | | | | 20 |
| Polymeric MDI | 55 | 55 | 55 | 55 | 55 | 55 | 55 |
| Density kg/m³ | 29 | 33 | 30 | 32 | 32 | 32 | 36 |
| UL-94V | V-0 | V-0 | V-0 | V-0 | V-0 | V-0 | NC |

Polyether polyol; SANNIX GP-3000V (Sanyo Chemical Industries, Ltd.)
Solution of triethylenediamine in dipropylene glycol; TEDA-L33 (Tosoh Corporation)
Stannous octoate; MRH-110 (Johoku Chemical Co., Ltd.)
Silicone foam stabilizer; L-540 (Dow Corning Toray Co., Ltd.)
Melamine cyanurate; STABIACE MC-2010N (Sakai Chemical Industry Co., Ltd.)

### Melamine (Mitsui Chemicals, Inc.)

Melamine polyphosphate; BUDIT3141 (CBC Co., Ltd.)
Ammonium polyphosphate; FR CROS484 (CBC Co., Ltd.)
Zinc borate; ZB2335 (Kinsei Matec Co., Ltd.)
TMCPP; tris(β-chloropropyl) phosphate (Daihachi Chemical Industry Co., Ltd.)

### Polymeric MDI (Tosoh Corporation)

Tables 1-1 and 1-2 show that the flame-retarded polyurethane foams containing the flame retardant according to the present invention, as compared to the foam containing a red phosphorus-based flame retardant, had equivalent or superior flame retardant properties and a low maximum heat release rate, while the total heat release after 5 minutes was low, and various physical properties of the foams were kept good.

The results shown in Table 2 indicate that when the flame retardant according to the present invention was used for polyurethane foam, as compared to when an aluminum organophosphinate was used, the density was lower, the total heat releases after 5 minutes, 10 minutes, and 20 minutes, the maximum heat release rate, and the weight reduction rate were all low, the amounts of shrinkages in the width direction and the thickness direction and the weight reduction rate after testing of the polyurethane foam were small, and non-flammability was exhibited.

Furthermore, the results in Table 3 show that also when the composition according to the present invention is used for flexible polyurethane foam, high flame retardancy can be achieved at a lower density.

1. A flame retardant composition for polyurethane foam having high carbonization properties, the flame retardant composition comprising:
a phosphorus compound represented by formula (1) below; and
one or more concomitant flame retardants selected from the group consisting of melamine phosphate, melamine pyrophosphate, melamine polyphosphate, melamine phthalate, melamine, melamine cyanurate, ammonium polyphosphate, ammonium phosphate, zinc phosphate, non-halogenated phosphoric esters, halogenated phosphoric esters, bromine compounds, barium borate, borax, zinc borate, zinc stannate, magnesium hydroxide, aluminum hydroxide, antimony trioxide, antimony pentoxide, calcium molybdate, zinc molybdate, magnesium molybdate, magnesium silicate, hydrated gypsum, kaolin clay, mica, calcium carbonate, alunite, basic magnesium carbonate, calcium hydroxide, wollastonite, and inclusion compounds composed of zinc hydrogen phosphate having a zeolite structure and ethylenediamine,
the one or more concomitant flame retardants being contained in an amount of 0 to 600 parts by weight based on 100 parts by weight of the phosphorus compound represented by formula (1): 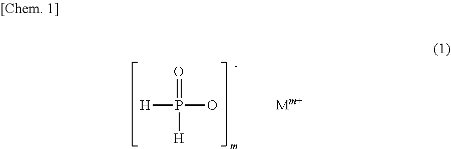
where M is Mg, Al, Ca, Ti, or Zn, and m is 2, 3, or 4.

2. The flame retardant composition for polyurethane foam according to claim 1, wherein the phosphorus compound represented by formula (1) is a salt of Al, and
the one or more concomitant flame retardants are one or more flame retardants selected from the group consisting of melamine, melamine cyanurate, melamine polyphosphate, melamine phosphate, diammonium hydrogen phosphate, ammonium polyphosphate, magnesium hydroxide, aluminum hydroxide, zinc borate, zinc stannate, antimony trioxide, antimony pentoxide, non-halogenated phosphoric esters, halogenated phosphoric esters, decabromodiphenyl ethane, trisdibromoneopentyl phosphate, wollastonite, and inclusion compounds composed of zinc hydrogen phosphate having a zeolite structure and ethylenediamine.

3. A flexible or semi-rigid flame-retarded polyurethane foam having high carbonization properties, comprising the flame retardant composition for polyurethane foam according to claim 1, wherein the flexible or semi-rigid flame-retarded polyurethane foam does not undergo melt dripping and satisfies UL94 V-0 performance.

4. The flexible or semi-rigid flame-retarded polyurethane foam having high carbonization properties according to claim 3, wherein the flame retardant composition for polyurethane foam contains the phosphorus compound represented by formula (1) and one or more concomitant flame retardants selected from the group consisting of melamine, melamine cyanurate, melamine polyphosphate, ammonium polyphosphate, and zinc borate, and the one or more concomitant flame retardants are contained in an amount of 0 to 100 parts by weight based on 100 parts by weight of the phosphorus compound represented by formula (1).

5. The flexible or semi-rigid flame-retarded polyurethane foam having high carbonization properties according to claim 3, not containing red phosphorus and/or an organic phosphinate.

6. A rigid flame-retarded polyurethane foam having high carbonization properties, comprising the flame retardant composition for polyurethane foam according to claim 1, wherein the rigid flame-retarded polyurethane foam satisfies performance such that when the polyurethane foam is heated at a radiant heat intensity of 50 kW/m² in cone calorimeter testing according to ISO-5660, a total heat release after 5 minutes is 10 MJ/m² or less, and a maximum heat release rate does not exceed 200 kW/m² for more than 10 seconds.

7. The rigid flame-retarded polyurethane foam having high carbonization properties according to claim 6, wherein when the polyurethane foam is heated at a radiant heat intensity of 50 kW/m² in cone calorimeter testing according to ISO-5660, a total heat release after 20 minutes is 8 MJ/m² or less.

8. The rigid flame-retarded polyurethane foam having high carbonization properties according to claim 6, wherein the flame retardant composition for polyurethane foam contains the phosphorus compound represented by formula (1) and a non-halogenated phosphoric ester and/or a halogenated phosphoric ester as the one or more concomitant flame retardants, and the one or more concomitant flame retardants are contained in an amount of 0 to 600 parts by weight based on 100 parts by weight of the phosphorus compound represented by formula (1).

9. The rigid flame-retarded polyurethane foam having high carbonization properties according to claim 8, wherein the flame retardant composition for polyurethane foam further contains zinc borate as a concomitant flame retardant.

10. The rigid flame-retarded polyurethane foam having high carbonization properties according to claim 6, not containing red phosphorus and/or an organic phosphinate.

11. The rigid flame-retarded polyurethane foam according to claim 6, wherein the rigid flame-retarded polyurethane foam is formed by spray foaming.

12. A flexible or semi-rigid flame-retarded polyurethane foam having high carbonization properties, comprising the flame retardant composition for polyurethane foam according to claim 2, wherein the flexible or semi-rigid flame-retarded polyurethane foam does not undergo melt dripping and satisfies UL94 V-0 performance.

13. A rigid flame-retarded polyurethane foam having high carbonization properties, comprising the flame retardant composition for polyurethane foam according to claim 2, wherein the rigid flame-retarded polyurethane foam satisfies performance such that when the polyurethane foam is heated at a radiant heat intensity of 50 kW/m² in cone calorimeter testing according to ISO-5660, a total heat release after 5 minutes is 10 MJ/m² or less, and a maximum heat release rate does not exceed 200 kW/m² for more than 10 seconds.

14. The flexible or semi-rigid flame-retarded polyurethane foam having high carbonization properties according to claim 4, not containing red phosphorus and/or an organic phosphinate.

15. The rigid flame-retarded polyurethane foam having high carbonization properties according to claim 7, not containing red phosphorus and/or an organic phosphinate.

16. The rigid flame-retarded polyurethane foam according to claim 7, wherein the rigid flame-retarded polyurethane foam is formed by spray foaming.

17. The rigid flame-retarded polyurethane foam having high carbonization properties according to claim 8, not containing red phosphorus and/or an organic phosphinate.

18. The rigid flame-retarded polyurethane foam according to claim 8, wherein the rigid flame-retarded polyurethane foam is formed by spray foaming.

19. The rigid flame-retarded polyurethane foam having high carbonization properties according to claim 9, not containing red phosphorus and/or an organic phosphinate.

20. The rigid flame-retarded polyurethane foam according to claim 9, wherein the rigid flame-retarded polyurethane foam is formed by spray foaming.
